(19) United States
(12) Patent Application Publication
(10) Pub. No.: US 2003/0031395 A1
(43) Pub. Date: Feb. 13, 2003

(54) High isolation gain flattening filter

(76) Inventors: Youfu Shao, Milpitas, CA (US); Sie Poon Chang, Cupertino, CA (US); Rong Li Zhu, Oakland, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 09/927,128

(22) Filed: Aug. 10, 2001

(51) Int. Cl. G02B 6/27; G02B 5/30

(52) U.S. Cl. 385/11; 359/483

(57) ABSTRACT

A high isolation gain flattening filter component includes the optical isolator with the built-in gain flattening filter (GFF) component which is disposed between the isolator core and one of the collimators wherein said isolator core includes a pair of birefringent crystals with therebetween a Faraday rotator together enclosed in a magnetic ring.

### BACKGROUND OF THE INVENTION

1. Field of the Invention

The present invention related to a new assembly method of high isolation gain flattening filter component which assemblies two discrete components, i.e., an isolator and a gain flattening filter, in a tube to reduce the insertion loss and cost.

2. Description of Related Art

The conventional structure of Erbium-doped fiber amplifiers (EDFAs) for multi-channel communication system uses gain flattening filter (GFF) to flat the gain spectrum to meet the requirement of DWDM transmission.

In an EDFA system of DWDM transmission, isolators are used to reduce back signals in the transmission system. In a single stage EDFA system, an isolator is put in front of a GFF both are at the end of the single stage EDFA system. In a two stages EDFA system, an isolator and a GFF are put at the middle of the two stages system. Because an isolator and a GFF are discrete components in an EDFA system, the two discrete components are connected by fiber. So the packaging size is big and the insertion loss is high.

The conventional two stages EDFA system is shown in FIG. 1. Referring to FIG. 1, the conventional two stages EDFA system comprises of ten components, the first tap coupler 101, the first optical isolator component 102, wavelength division multiplexer (WDM) 103, Erbium-doped fiber 104, the first optical isolator component 105, gain flattening fiber (GFF) component 106, wavelength division multiplexer 107, Erbium-doped fiber 108, the second optical isolator 109, the second tap coupler 110.

Light signal transmits through the first tap coupler 101 and the first optical isolator component 102 to avoid back signals from the amplified signals. After passed the first optical isolator component 102, the light signal transmits through WDM 103 to combine with the pump laser signal to excite EDF104 to amplify the original light signals. After the light signals amplified, it will transmit through the second optical isolator component 105 to avoid the back signals and through the GFF component 106 to flat the signal gain of each channel. After GFF component 106, the amplified light signal will enter the second stage of the EDFA. WDM 107 provides pump laser signal with the amplified light signal from GFF component 106 to amplify the signal again by EDF 108. After EDF 108, the amplified light signal transmits through the second isolator component 109 to avoid back signals and through the second tap coupler 110 to continue transmission in the DWDM system.

U.S. Pat. No. 6,215,581 shows the gain stage including GFF in a EDFA system. U.S. Pat. Nos. 6,166,851, 6,134,047, 6,088,152, and 5,900,969 show the discrete positions of isolators and gain flattening filters. All of them do not have the idea of hybridizing the isolator and gain flattening filter.

### BRIEF SUMMARY OF THE INVENTION

An object of the present invention is to provide a high isolation gain flattening filter component, which has no discrete regular optical isolator and GFF with an optical fiber connected therebetween while instead generally being of an isolator with a built-in gain flattening filter therein.

The integration component can simplify EDFA structure, minimize the compact size, ease EDFA assembly, and reduce material cost and labor cost. According to an aspect of the invention, the high isolation gain flattening filter component includes the optical isolator with the built-in gain flattening filter (GFF) component which is disposed between the isolator core and one of the collimators. The bandwidth of the isolator should meet the requirement of the component. GFF is mostly fabricated by thin film technology. On the one side of the filter substrate, it is the GFF functional coating layer. On another side of the GFF, it is possible to have anti-reflection coating to decrease the excess loss. Due to the spectrum curve is related to the incident angle of light, the relative angle between GFF and the optical isolator should be adjusted during component assembly to achieve low error function.

The integrated component is assembled into a small size package: Φ5.5 mm×34 mm. The peak-peak error function is less than 1.0 dB, and the isolation (single-stage isolator) is greater than 32 dB over the wavelength range.

### BRIEF DESCRIPTION OF THE DRAWINGS

FIG. 1 is the conventional two stages EDFA configuration.

FIG. 2 is the new integrated high isolation gain flattening filter component.

FIG. 3 is the new two stages EDFA system.

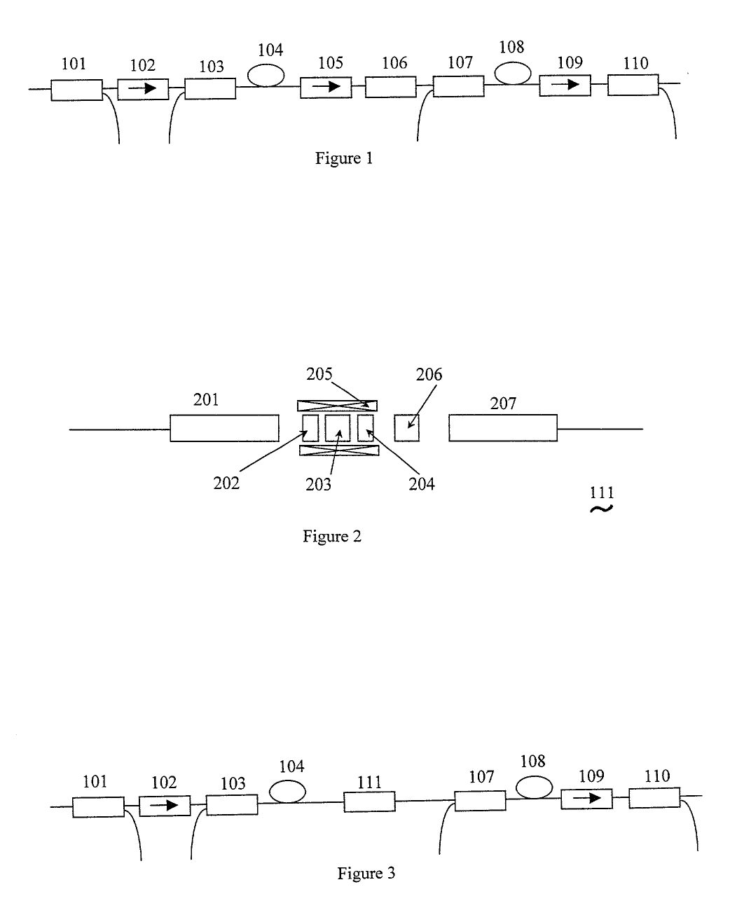

### DETAIL DECRIPTION OF THE INVENTION

Referring to FIG. 2, the new high isolation gain flattening filter component 111 comprises of the first optical fiber collimator 201, the first birefringent crystal 202, Faraday rotator 203, the second birefringent crystal 204, magnetic rings 205, gain flattening filter 206, and the second optical fiber collimator 207.

The isolator core is assembled by the first birefringent crystal 202, Faraday rotator 203, the second birefringent crystal204, commonly enclosed within a magnetic ring 205.

In this new high isolation gain flattening filter component 111, the first collimator 201 is stick with the isolator core by adhesive to be an isolator component.

In this new high isolation gain flattening filter component 111, the gain flattening filter 206 is stick on the collimator 207 by adhesive to be the gain flattering filter component.

In this new high isolation gain flattening filter component 111, there is no fiber connection between the isolator component and the gain flattening filter component, while instead the isolator component and the gain flattening filter component are internally.

A tube is used to pack the isolator component and the gain flattering filter component together by spliced.

Referring to FIG. 3, different from the conventional system, the new two stages EDFA system comprises of nine components, tap coupler 101, optical isolator 102, wavelength division multiplexer (WDM) 103, Erbium-doped fiber 104, high isolation gain flattening filter component 111, wavelength division multiplexer 107, Erbium-doped fiber 108, optical isolator 109, tap coupler 110. Understandably, the high isolation gain flattening filter component 111 replaces the old isolator 105 and the successively connected GFF 106 of the conventional system.

Light signal transmits through the first tap coupler 101 and the first optical isolator 102 to avoid back signals from the amplified signals. After passed the first optical isolator 102, the light signal transmits through WDM 103 to combine with the pump laser signal to excite EDF 104 to amplify the original light signals. After the light signals amplified, it will transmit through the high isolation gain flattening filter component 111 to avoid the back signals and to flat the signal gain of each channel. After high isolation gain flattening filter component 111, the amplified light signal will enter the second stage of the EDFA. WDM 107 provide pump laser signal with the amplified light signal from GFF 106 to amplify the signal again by EDF 108. After EDF 108, the amplified light signal transmits through an isolator 109 to avoid back signals and through the tap coupler 110 to continue transmission in the DWDM system.

To finely adjustably achieve the high isolation of the high isolation gain flattening filter component 111, the assembling among the GFF 206, the second optical fiber collimator 207, and the isolator core (i.e., the subassembly composed of the magnetic ring 205 and the associated first birefringent crystal 202, the Faraday rotator 203 and the second birefringent crystal 204 commonly enclosed therein), can be alternately rearranged by following the principle disclosed in the copending application Ser. No. 09/844,547 filed Apr. 27, 2001.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A high isolation gain flattening filter component comprising;
an isolator component comprising the first collimator and an optical isolator core;
said optical isolator core comprising the first birefringent crystal, a Faraday rotator, and the second birefringent crystal, commonly enclosed within a magnetic ring;
a gain flattening filter component comprising a gain flattening filter and the second collimator; wherein
said gain flattening filter is disposed between the second collimator and said isolator core.

2. The component as defined in claim 1, wherein said gain flattening filter is attached to the second collimator.

3. An isolator assembly comprising:
a pair of opposite collimators with two outwardly extending pigtail fibers at two ends, respectively; and
an isolator core including two birefringent crystals with a Faraday rotator therebetween, of which at least two enclosed in a magnetic ring; wherein
a fain flattening filter disposed between the isolator core and one of said collimators.

4. The component as defined in claim 3, wherein said gain flattening filter is attached to said one of the collimators.

5. A two-stage EDFA system comprising:
a first Wavelength Division Multiplexer (WDM);
a first Erbium-Doped Fiber (EDF) connected to said first WDM;
a high isolation gain flattening filter component connected to said first EDF opposite to said first WDM, said high isolation gain flattening filter including an isolator with a built-in Gain Flattening Filter (GFF);
a second WDM connected to said high isolation gain flattening filter opposite to said first EDF; and
a second EDF connected to said second WDM opposite to said high isolation gain flattening filter.

6. The system as defined in claim 5, wherein said isolator includes two collimators with an isolator core therebetween, and said GFF is positioned between the isolator core and one of said collimators.
